(19) United States
(12) Patent Application Publication
(10) Pub. No.: US 2009/0184939 A1
(43) Pub. Date: Jul. 23, 2009

(54) GRAPHICAL OBJECT MANIPULATION WITH A TOUCH SENSITIVE SCREEN

(75) Inventors: Gil WOHLSTADTER, Givataim (IL); Rafi ZACHUT, Rishon-LeZion (IL); Amir KAPLAN, Hod-HaSharon (IL)

Correspondence Address: MARTIN D. MOYNIHAN d/b/a PRTSI, INC., P.O. BOX 16446, ARLINGTON, VA, 22215, US

(73) Assignee: N-trig Ltd., Kfar-Saba (IL)

(21) Appl. No.: 12/357,427

(22) Filed: Jan. 22, 2009

Related U.S. Application Data
(60) Provisional application No. 61/006,587, filed on Jan. 23, 2008.

(51) Int. Cl. G06F 3/041; G06F 3/033

(52) U.S. Cl. 345/173; 715/863

(57) ABSTRACT

A method for graphical object manipulation using a touch sensitive screen, the method comprises detecting a presence of two user interactions within a defined boundary of a graphical object displayed on the touch sensitive screen, determining position of each of the two user interactions with respect to the graphical object, detecting displacement of at least one of the two user interactions, and manipulating the graphical object based on the displacement to maintain the same position of each of the two user interactions with respect to the graphical object.

### RELATED APPLICATION/S

The present application claims the benefit under section 35 U.S.C. §119(e) of U.S. Provisional Application No. 61/006,587 filed on Jan. 23, 2008 which is incorporated herein by reference in its entirety.

### FIELD OF THE INVENTION

The present invention, in some embodiments thereof, relates to touch sensitive computing systems and more particularly, but not exclusively to graphic manipulation of objects displayed on touch sensitive screens.

### BACKGROUND OF THE INVENTION

Digitizing systems that allow a user to operate a computing device with a stylus and/or finger are known. Typically, a digitizer is integrated with a display screen, e.g. over-laid on the display screen, to correlate user input, e.g. stylus interaction and/or finger touch on the screen with the virtual information portrayed on display screen. Position detection of the stylus and/or fingers detected provides input to the computing device and is interpreted as user commands. In addition, one or more gestures performed with finger touch and/or stylus interaction may be associated with specific user commands. Typically, input to the digitizer sensor is based on electromagnetic transmission provided by the stylus touching the sensing surface and/or capacitive coupling provided by the finger touching the screen.

U.S. Pat. No. 6,690,156 entitled “Physical Object Location Apparatus and Method and a Platform using the same” and U.S. Pat. No. 7,292,229 entitled “Transparent Digitizer” both of which are assigned to N-trig Ltd., the contents of both which are incorporated herein by reference, describe a positioning device capable of locating multiple physical objects positioned on a Flat Panel Display (FPD) and a transparent digitizer sensor that can be incorporated into an electronic device, typically over an active display screen of the electronic device. The digitizer sensor includes a matrix of vertical and horizontal conductive lines to sense an electric signal. Typically, the matrix is formed from conductive lines patterned on two transparent foils that are superimposed on each other. Positioning the physical object at a specific location on the digitizer provokes a signal whose position of origin may be detected.

U.S. Pat. No. 7,372,455, entitled “Touch Detection for a Digitizer” assigned to N-Trig Ltd., the contents of which is incorporated herein by reference, describes a digitizing tablet system including a transparent digitizer sensor overlaid on a FPD. The transparent digitizing sensor includes a matrix of vertical and horizontal conducting lines to sense an electric signal. Touching the digitizer in a specific location provokes a signal whose position of origin may be detected. The digitizing tablet system is capable of detecting position of both physical objects and fingertip touch using same conductive lines.

US Patent Application Publication No. 20070062852, entitled “Apparatus for Object Information Detection and Methods of Using Same” assigned to N-Trig Ltd., the contents of which is incorporated herein by reference, describes a digitizer sensor sensitive to capacitive coupling and objects adapted to create a capacitive coupling with the sensor when a signal is input to the sensor. A detector associated with the sensor detects an object information code of the objects from an output signal of the sensor. Typically the object information code is provided by a pattern of conductive areas on the object. Typically, the object information code provides information regarding position, orientation and identification of the object.

U.S. Patent Application Publication No. US20060026521 and U.S. Patent Application Publication No. US20060026536, entitled “Gestures for touch sensitive input devices” the contents of which are incorporated herein by reference, describe reading data from a multi-point sensing device such as a multi-point touch screen where the data pertains to touch input with respect to the multi-point sensing device, and identifying at least one multi-point gesture based on the data from the multi-point sensing device. In one example a gestural method includes displaying a graphical image on a display screen, detecting a plurality of touches at the same time on a touch sensitive device, and linking the detected multiple touches to the graphical image presented on the display screen. After linking, the graphical image can change in response to motion of the linked multiple touches. Changes to the graphical image can be based on calculated changes in distances between two fingers, e.g. for a zoom gestures or based on detected change in position of the two fingers, e.g. for a pan gesture. In one example, a rotational movement of the fingers is detected and a rotate signal for the image is generated in response to the detected rotation of the fingers.

### SUMMARY OF THE INVENTION

According to an aspect of some embodiments of the present invention there is provided a method for manipulating position, size and/or orientation of one or more graphical objects displayed on a touch-sensitive screen by directly interacting with the touch-sensitive screen in an intuitive maimer using two or more user interactions. The user interactions may include two or more of fingertip, stylus and/or conductive object. According to some embodiments of the present invention, the relative location of the user interactions with respect to the graphical object being manipulated is maintained throughout the manipulation. According to some embodiments of the present invention the manipulation does not require analyzing trajectories and/or characterizing a movement path of the user interactions and thereby the manipulation can be performed at relatively low processing costs.

As used herein, the terms multi-point and/or multi-touch input refers to input obtained with at least two user interactions simultaneously interacting with a digitizer sensor, e.g. at two different locations on the digitizer. Multi-point and/or multi-touch input may include interaction with the digitizer sensor by touch and/or hovering. Multi-point and/or multi-touch input may include interaction with a plurality of different and/or same user interactions. Different user interactions may include a fingertip, a stylus, and a conductive object, e.g. token.

An aspect of some embodiments of the present invention is the provision of a method for graphical object manipulation using a touch sensitive screen, the method comprising: detecting a presence of two user interactions within a defined boundary of a graphical object displayed on the touch sensitive screen; determining relative position of each of the two user interactions with respect to the graphical object; detecting displacement of at least one of the two user interactions; manipulating the graphical object based on the displacement to maintain the same relative position of each of the two user interactions with respect to the graphical object.

Optionally, the manipulating of the graphical object provides for maintaining an angle between a line segment connecting the position of two user interactions on the graphical object and an axis of the graphical object in response to the displacement.

Optionally, the manipulating includes resizing of the graphical object along one axis of the graphical object, and wherein the resizing is determined by a ratio of a distance between the positions of the two user interactions along the axis of the graphical object after the displacement and a distance between the positions of the two user interactions along the axis of the graphical object before the displacement.

An aspect of some embodiments of the present invention is the provision of a method for graphical object manipulation using a touch sensitive screen, the method comprising: determining global coordinates of a plurality of user interactions on a Is touch sensitive screen, wherein the global coordinates are coordinates with respect to a global coordinate system locked on the touch sensitive screen; detecting a presence of two user interactions within a defined boundary of a graphical object displayed on the touch sensitive screen, wherein the presence is determined from the global coordinates of the two user interactions and the global coordinates of the defined boundary of the graphical object; defining a local coordinate system for the at least one graphical object, wherein the local coordinate system is locked on the at least one graphical object; determining coordinates of each of the two user interactions in the local coordinate system; detecting displacement of a position of at least one of the two user interactions; and manipulating the at least one graphical object in response to the displacement to maintain the same coordinates of the two user interactions determined in the local coordinate system.

Optionally, the manipulating includes one or more of resizing, translating and rotating the graphical object.

Optionally, method comprises updating the local coordinate system of the graphical object in response to the displacement.

Optionally, the method comprises determining a transformation between the global and the local coordinate system and updating the transformation in response to the displacement.

Optionally, the transformation is defined based on a requirement that the coordinates of the two user interactions in the local coordinate system determined prior to the displacement is the same as the coordinates of the two user interactions in the updated local coordinate system.

Optionally, the manipulating of the graphical object provides for maintaining an angle between a line segment connecting the coordinates of two user interactions on the graphical object and an axis of the local coordinate system of the graphical object in response to the displacement and manipulating.

Optionally, the manipulating includes resizing of the graphical object along one axis of the local coordinate system, and wherein the resizing is determined by a ratio of a distance between the two user interactions along the axis of the local coordinate system after the displacement and a distance between the two user interactions along the axis of the local coordinate system before the displacement.

Optionally, the manipulating includes resizing of the graphical object, and wherein the resizing is determined by a ratio of a distance between the two user interactions after the displacement and a distance between the user interactions before the displacement.

Optionally, the manipulating is performed as long as the at least two user interactions maintain their presence on the graphical object.

Optionally, the defined boundary encompasses the graphical object as well as a frame around the graphical object.

Optionally, the presence of the at least two user interactions is detected in response to stationary positioning of the two user interactions within the defined boundary of the graphical object for a pre-defined time period.

Optionally, the touch sensitive screen includes at least two graphical objects and wherein a first set of user interactions is operative to manipulate a first graphical object and a second set of user interactions is operative to manipulate a second graphical object.

Optionally, the first and second objects are manipulated simultaneously and independently.

Optionally, the graphical object is an image.

Optionally, aspect ratio of the graphical object is held constant during the manipulation.

Optionally, the presence of one of the two user interactions is provided by hovering over the touch sensitive screen.

Optionally, the presence of one of the two user interaction is provided by touching the touch sensitive screen.

Optionally, the two user interactions are selected from a group including: fingertip, stylus, and conductive object or combinations thereof.

Optionally, the manipulation does not require determination of a trajectory of the two user interactions.

Optionally, the manipulation does not require analysis of the trajectory.

Optionally, the touch sensitive screen is a multi-touch screen.

Optionally, the touch sensitive screen comprises a sensor including two orthogonal sets of parallel conductive lines forming a grid.

Optionally, the sensor is transparent.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is an exemplary simplified block diagram of a digitizer system in accordance with some embodiments of the present invention;

FIG. 2 is a schematic illustration of a multi-point fingertip touch detection method in accordance with some embodiments of the present invention;

FIGS. 3A and 3B are schematic illustrations showing two fingertip interactions used to rescale and pan an image in accordance with some embodiments of the present invention;

FIG. 4 is an exemplary flow chart of a method for resizing and scaling a graphical object based on translational movement of user interactions on a touch sensitive screen in accordance with some embodiments of the present invention.

FIGS. 5A and 5B are schematic illustrations showing geometrical transformation in response to rotation of two fingertip interactions in accordance with some embodiments of the present invention;

FIGS. 6A and 6B are schematic illustrations showing global manipulation of a graphical object in response to rotational movement performed with two user interactions in accordance with some embodiments of the present invention;

FIG. 7 is an exemplary flow chart of a method for manipulating a graphical object based on translational and rotational movement of user interactions on a touch sensitive screen in accordance with some embodiments of the present invention; and

FIGS. 8A and 8B are schematic illustrations showing fingertip interactions used to simultaneously and independently manipulate two different objects in accordance with some embodiments of the present invention.

### DESCRIPTION OF SPECIFIC EMBODIMENTS OF THE INVENTION

The present invention, in some embodiments thereof, relates to touch sensitive computing systems and more particularly, but not exclusively to graphic manipulation of objects displayed on touch sensitive screens.

An aspect of some embodiments of the present invention provides manipulating position, size and orientation of one or more graphical objects displayed on a touch-sensitive screen by positioning a two or more user interactions on a graphical object, e.g. within a defined boundary and/or on a defined boundary of graphical object and then moving the user interaction in a manner that reflects a desired manipulation. According to some embodiments of the present invention, positioning one or more user interactions on the graphical object serves to link the user interactions on the graphical object as well as to link and/or lock the user interactions to specific locations on the graphical object. According to some embodiments of the present invention, the specific locations of the user interaction with respect to the graphical object at the time of linking the user interaction to the object is recorded. According to some embodiments of the present invention, in response to displacement of the user interaction(s), the object is geometrically manipulated so that the user interaction(s), although displaced, still appear on the same relative position on the graphical object. According to some embodiments of the present invention, an object is manipulated periodically while linked to the user interactions so that the object appears to a user to move together with the user interactions in a continuous motion. In some exemplary embodiments, linking between the user interactions and the object is terminated in response to the user interactions being lifted away from the object, e.g. above a hovering height. It is noted that a defined boundary of a graphical object may be defined as the edges of the graphical object or may include a defined frame around the edges of the graphical object.

The present inventors have found that linking the position of each user interaction to a specific position on the object leads to results that are intuitive and contingent with results that a user would expect. Additionally, the present inventors have found that trajectory analysis, motion path analysis or characterization of shape of path, of the user interaction itself is not required for manipulating the object when manipulation of the object is based on that link between a location on the object and the location of the user interaction.

Prior art systems provide object manipulation based on gesture recognition. A user performs a pre-defined movement with the user interactions. The movement path of the gestures is determined and characterized for recognition. Typically, tracking the path of the user interaction is required so that the gesture can be recognized. Typically, tracking algorithms make up a significant part of the processing power required for interaction with the digitizer. In addition, when manipulation is based on gesture recognition, the type of movement that can be performed is limited to structured gestures that are required to be performed in pre-defined manners and/or in a pre-defined order so that they may be recognized. Based on the recognized movement, a movement command is generated.

It is perhaps paradoxical, that linking the interaction to specific positions on the object, while requiring less computation than the method of the prior art, actually results in more intuitive transformation of the image which provides only an indirect connection between the motion of the interactions and the motion of the image.

According to some embodiments of the present invention, each manipulation of the graphical object is based on a small number of sampled data, e.g. typically two frames, indicating displacement of at least one user interaction over a pre-defined displacement threshold. In some exemplary embodiments, the pre-defined displacement threshold is operative to avoid jitter. Analysis of the trailing path of the user interaction(s) prior to the manipulation is typically not required nor is analysis of a path taken to achieve displacement over the displacement threshold. In some exemplary embodiments, in response to detecting a displacement of a user interaction over a displacement threshold, the coordinates, e.g. global coordinates, of the user interaction is sent to the host and the host manipulates the linked graphical object so that the current position of the user interactions are in their pre-defined linked position on the graphical object. In some exemplary embodiments, a displacement vector of the user interaction, e.g. change in positions of the user interactions, is communicated, e.g. transmitted, to the host. Maintaining the relationship between a position on the object and a position of the user interactions provides the user with predictable results that precisely follow the movement of the user interaction without rigorous processing, e.g. without processing associated with recognizing a gesture.

Geometrical manipulation may include for example, a combination of resizing, translation, e.g. panning, and rotation of the graphical object. The pattern of movement required to achieve each of these types of manipulations need not be structured and a single motion by the user interaction may results two or more of the possible types of manipulations occurring simultaneously, e.g. resizing and rotating in response to rotation of a user interaction(s) while distancing one user interaction from another.

In some exemplary embodiments and depending on the particular application, one or more geometrical relationships are maintained during manipulation. In some exemplary embodiments, aspect ratio is maintained during resizing, e.g. when the object is an image. For example, in response to a user expanding the image in only the horizontal direction by distancing two fingers in the horizontal direction, the image is reconfigured to be resized equally in the vertical direction.

According to some embodiments of the present invention, the graphical object is an image, display window, e.g. including text, geometrical objects, text boxes, and images or an object within a display window. In some exemplary embodiments positions of each of the user interaction are determined based on a global coordinate system of the touch screen as well as based on a local coordinate system of the object, e.g. a normalized coordinate system of the object.

According to some embodiments of the present invention, a plurality of graphical objects may be manipulated simultaneously. For example in a multi-touch screen, two or more fingers may be linked to a first image displayed on the screen while two or more other fingers may be linked to a second image displayed on the screen. The different images may be manipulated concurrently and independently from each other based on movements of each set of fingers.

According to some embodiments of the present invention, a digitizer system sends information regarding the current location of each user interaction to a host computer. According to some embodiments of the present invention, linking of the user interactions to the graphical objects displayed by the host and determining the local coordinates of the user interaction with respect to the graphical objects is performed on the level of the host.

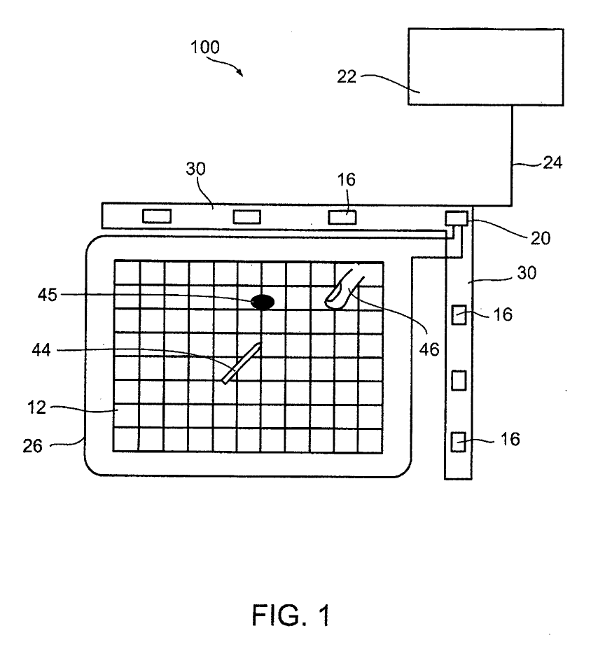

Referring now to the drawings, FIG. 1 illustrates an exemplary simplified block diagram of a digitizer system in accordance with some embodiments of the present invention. The digitizer system 100 may be suitable for any computing device that enables touch input between a user and the device, e.g. mobile and/or desktop and/or tabletop computing devices that include, for example, FPD screens. Examples of such devices include Tablet PCs, pen enabled lap-top computers, tabletop computer, PDAs or any hand held devices such as palm pilots and mobile phones or other devices. As shown in FIG. 1, digitizer system 100 comprises a sensor 12 including a patterned arrangement of conductive lines, which is optionally transparent, and which is typically overlaid on a FPD. Typically sensor 12 is a grid based sensor including horizontal and vertical conductive lines.

According to some embodiments of the present invention, circuitry is provided on one or more PCB(s) 30 positioned around sensor 12. According to some embodiments of the present invention, one or more ASICs 16 positioned on PCB(s) 30 comprises circuitry to sample and process the sensor's output into a digital representation. The digital output signal is forwarded to a digital unit 20, e.g. digital ASIC unit also on PCB 30, for further digital signal processing. According to some embodiments of the present invention, digital unit 20 together with ASIC 16 serves as the controller of the digitizer system and/or has functionality of a controller and/or processor. Output from the digitizer sensor is forwarded to a host 22 via an interface 24 for processing by the operating system or any current application.

According to some embodiments of the present invention, sensor 12 comprises a grid of conductive lines made of conductive materials, optionally Indium Tin Oxide (ITO), patterned on a foil or glass substrate. The conductive lines and the foil are optionally transparent or are thin enough so that they do not substantially interfere with viewing an electronic display behind the lines. Typically, the grid is made of two layers, which are electrically insulated from each other. Typically, one of the layers contains a first set of equally spaced parallel conductive lines and the other layer contains a second set of equally spaced parallel conductive lines orthogonal to the first set. Typically, the parallel conductive lines are input to amplifiers included in ASIC 16. Optionally the amplifiers are differential amplifiers.

Typically, the parallel conductive lines are spaced at a distance of approximately 2-8 mm, e.g. 4 mm, depending on the size of the FPD and a desired resolution. Optionally the region between the grid lines is filled with a non-conducting material having optical characteristics similar to that of the (transparent) conductive lines, to mask the presence of the conductive lines. Optionally, the ends of the lines remote from the amplifiers are not connected so that the lines do not form loops.

Typically, ASIC 16 is connected to outputs of the various conductive lines in the grid and functions to process the received signals at a first processing stage. As indicated above, ASIC 16 typically includes an array of amplifiers to amplify the sensor's signals. According to some embodiments of the invention, digital unit 20 receives the sampled data from ASIC 16, reads the sampled data, processes it and determines and/or tracks the position of physical objects, such as a stylus 44 and a token 45 and/or a finger 46, and/or an electronic tag touching and/or hovering above the digitizer sensor from the received and processed signals. According to some embodiments of the present invention, digital unit 20 determines the presence and/or absence of physical objects, such as stylus 44, and/or finger 46 over time. In some exemplary embodiments of the present invention, hovering of an object, e.g. stylus 44, finger 46 and hand, is also detected and processed by digital unit 20. According to embodiments of the present invention, calculated position and/or tracking information is sent to the host computer via interface 24.

According to some embodiments of the invention, host 22 includes at least a memory unit and a processing unit to store and process information obtained from digital unit 20. According to some embodiments of the present invention memory and processing functionality may be divided between any of host 22, digital unit 20, and/or ASIC 16 or may reside in only host 22, digital unit 20 and/or there may be a separated unit connected to at least one of host 22, and digital unit 20.

In some exemplary embodiments of the invention, an electronic display associated with the host computer displays images and/or other graphical objects. Optionally, the images and/or the graphical objects are displayed on a display screen situated below a surface on which the object is placed and below the sensors that sense the physical objects or fingers. Typically, interaction with the digitizer is associated with images and/or graphical objects concurrently displayed on the electronic display.

Stylus and Object Detection and Tracking

According to some embodiments of the invention, digital unit 20 produces and controls the timing and sending of a triggering pulse to be provided to an excitation coil 26 that surrounds the sensor arrangement and the display screen. The excitation coil provides a trigger pulse in the form of an electric or electromagnetic field that excites passive circuitry, e.g. passive circuitry, in stylus 44 or other object used for user touch to produce a response from the stylus that can subsequently be detected. According to some embodiments of the present invention the stylus is a passive element. Optionally, the stylus comprises a resonant circuit, which is triggered by excitation coil 26 to oscillate at its resonant frequency. Optionally, the stylus may include an energy pick-up unit and an oscillator circuit. At the resonant frequency the circuit produces oscillations that continue after the end of the excitation pulse and steadily decay. The decaying oscillations induce a voltage in nearby conductive lines which are sensed by the sensor 12. According to some embodiments of the present invention, two parallel sensor lines that are close but not adjacent to one another are connected to the positive and negative input of a differential amplifier respectively. The amplifier is thus able to generate an output signal which is an amplification of the difference between the two sensor line signals. An amplifier having stylus 44 on one of its two sensor lines will produce a relatively high amplitude output. In some exemplary embodiments, stylus detection and tracking is not included and the digitizer sensor only functions as a capacitive sensor to detect the presence of fingertips, body parts and conductive objects, e.g. tokens.

Fingertip and Token Detection

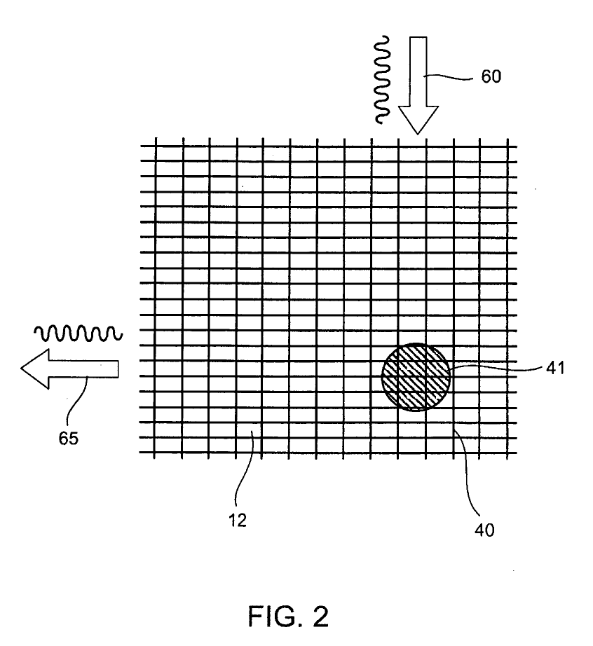

Reference is now made to FIG. 2 showing a schematic illustration of fingertip and/or token touch detection based on a junction touch method for detecting multiple fingertip touch. According to some embodiments of the present invention, for capacitive touch detection based on junction touch method, digital unit 20 produces and sends an interrogation signal such as a triggering pulse to at least one of the conductive lines. Typically, the interrogation pulses and/or signals are pulse sinusoidal signals. Optionally, the interrogation pulses and/or signals are pulse modulated sinusoidal signals. At each junction, e.g. junction 40, in sensor 12 a certain capacitance exists between orthogonal conductive lines.

In an exemplary embodiment, an AC signal 60 is applied to one or more parallel conductive lines in the two-dimensional sensor matrix 12. When a finger touches the sensor at a certain position 41 where signal 60 is induced on a line, e.g. active and/or driving line, the capacitance between the conductive line through which signal 60 is applied and the corresponding orthogonal conductive lines, e.g. the passive lines, at least proximal to the touch position changes and signal 60 crossing to corresponding orthogonal conductive lines produces a lower amplitude signal 65, e.g. lower in reference to a base-line amplitude. A base-line amplitude is an amplitude recorded while no user interaction is present. Typically, the presence of a finger decreases the amplitude of the coupled signal by 15-20% or 15-30% since the finger typically drains current from the lines to ground. Optionally, a finger hovering at a height of about 1-2 cm above the display can be detected.

Using this junction touch method, more than one fingertip touch and/or capacitive object (token) can be detected at the same time (multi-touch). Typically, an interrogation signal is transmitted to each of the driving lines in a sequential manner. Output is simultaneously sampled from each of the passive lines in response to each transmission of an interrogation signal to a driving line.

It should be noted that the embodiments of FIGS. 1-2 are presented as the best mode “platform” for carrying out the invention. However, in its broadest form the invention is not limited to any particular platform and can be adapted to operate on any digitizer or touch or stylus sensitive display or screen that accepts and differentiates between two simultaneous user interactions.

Digitizer systems used to detect stylus and/or finger touch location may be, for example, similar to digitizer systems described in incorporated U.S. Pat. No. 6,690,156, U.S. Pat. No. 7,292,229 and/or U.S. Pat. No. 7,372,455. The present invention may also be applicable to other digitized sensor and touch screens known in the art, depending on their construction.

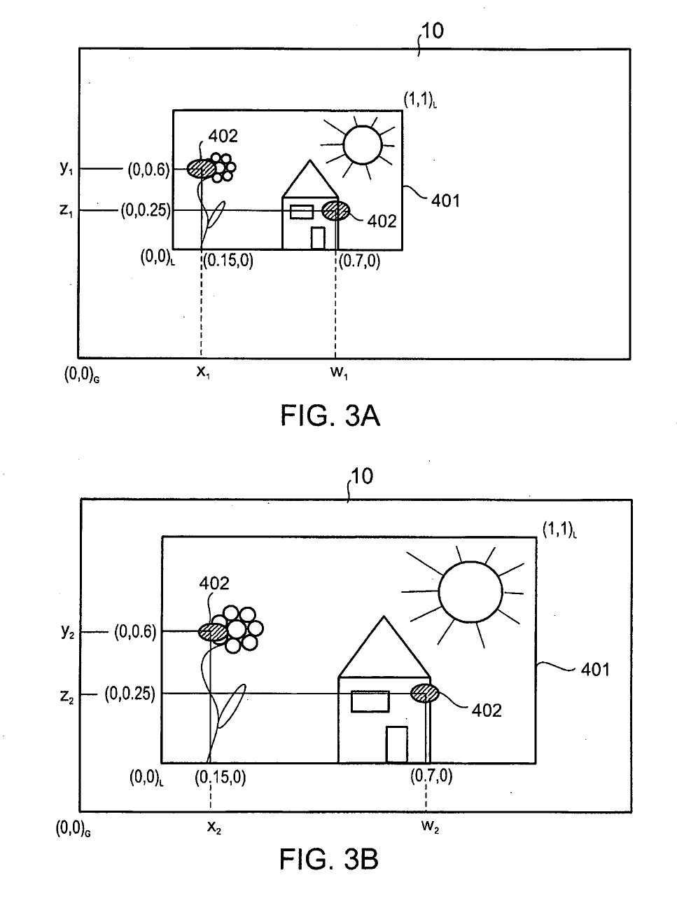

Reference is now made to FIGS. 3A-3B schematically illustrating a fingertip interaction used to resize and/or pan an image in accordance with some embodiments of the present invention. According to some embodiments of the present invention, a graphical object such as image 401 is displayed on a touch sensitive screen 10. According to some embodiments of the present invention two fingertips 402 over the area of image 401 are used to manipulate the image. According to some embodiments of the present invention, the location of each finger 402 is determined based on a global coordinate system of screen 10 denoted by ‘G’, e.g. (xᵢ,y₁) and (w₁,z₁) and linked to a local coordinate system of image 401 denoted by ‘L’, e.g. (0.15, 0.6) and (0.7, 0.25). According to some embodiments of the present invention, the local coordinate system is normalized, e.g. extending between (0,0)_{L} and (1,1)_{L}.

According to some embodiments of the present invention, when the fingertips 402 move with respect to the global coordinate system from points (x₁,y₁) and (w₁,z₁) in FIG. 3A to points (x₂,y₂) and (w₂,z₂) in FIG. 3B, the positioning and size of image 401 is manipulated so that the position of fingertips 402 are substantially stationary with respect to the local coordinate system of image 401 and are maintained on points (0.15, 0.6) and (0.7, 0.25). According to some embodiments of the present invention, the local coordinate system of image 401 is reconfigured and resized in response to each recorded displacement of fingertips 402 over a pre-defined displacement and/or transformation threshold. In some exemplary embodiments, the threshold corresponds to translation of more than 1 mm and/or resizing above 2% of a current size.

According to some embodiments of the present invention, an assumption is made that the user interactions do not cross so that the user interactions linked to an object can be distinguished without requiring any tracking. In some exemplary embodiments, in case of ambiguity the user interactions are distinguished based on 5 their proximity to previous positions of the user interactions when there was no ambiguity.

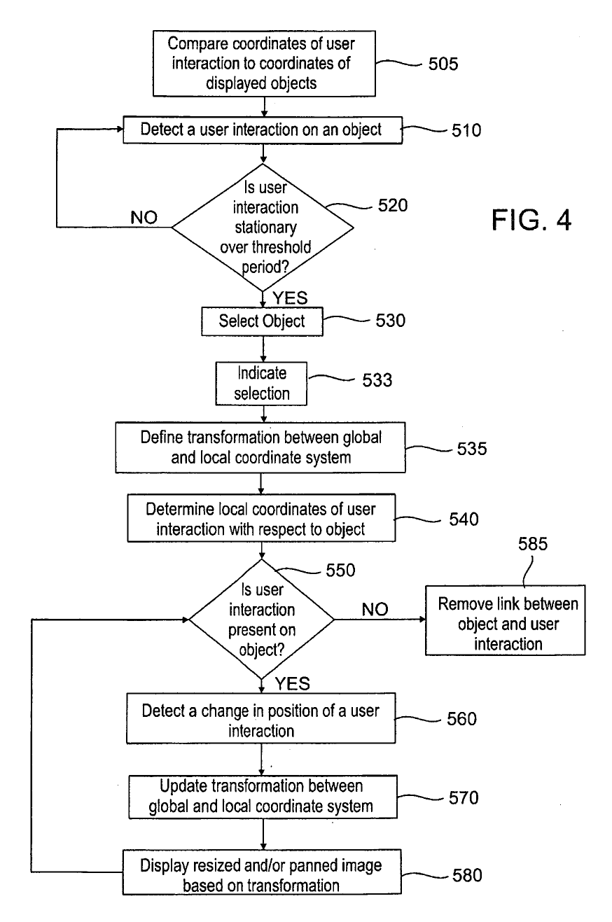

Reference is now made to FIG. 4 showing an exemplary flow chart of a method for manipulating a graphical object based on translational movement of user interactions on a touch sensitive screen in accordance with some embodiments of the present invention. According to some embodiments, coordinates of detected user interactions with respect to the touch sensitive screen are transmitted to a host 22 and host 22 compares coordinates, e.g. global coordinates, of the detected user interaction to coordinates, e.g. global coordinates, of one or more currently displayed objects (block 505). In response to two or more user interactions having coordinates that are within a defined area of a currently displayed object, the user interactions are identified and determined to be on that currently displayed object (block 510). According to some embodiments of the present invention, a manipulation procedure begins if the user interactions position is maintained and/or stationary over a presence threshold period while the object is being displayed. According to some exemplary embodiments, the digitizer detects the presence of the user interactions and reports it to the host, so that no presence threshold is required at the level of the host.

Once the threshold period is completed (block 520), the object(s) over which the user interactions are positioned is selected for manipulation with the identified user interactions detected on the object (block 530).

In some exemplary embodiments, indication is given to the user that the object(s) has been selected, e.g. a border is placed around the object, an existing border changes colors and/or is emphasized in some visible manner (block 533).

According to some embodiments of the present invention, a local coordinate system for each of the objects selected is defined, e.g. a normalized (or un-normalized) 3o coordinate system (block 535). According to some embodiments of the present invention a transformation between the global coordinate system of the display and/or touch sensitive screen and the local coordinate system is determined.

According to some embodiments of the present invention, while the user interaction is still stationary, local coordinates of the position of the user interaction with respect to the selected object is determined (block 540). Typically, the local coordinates are determined based on the defined transformation.

According to some embodiments of the present invention, while the identified user interactions are maintained on the object (block 550) changes in the position of the user interactions are detected (block 560). A change in the position of the user interactions includes a change of position of at least one user interaction with respect to the touch screen, e.g. the global coordinate system. The presence of a user interaction may be based on touching and/or hovering of the user interaction. Typically, a change in the position is determined by the digitizer itself, e.g. digital unit 20 although it may be determined by the host 22. In some exemplary embodiments, the threshold used to determine a change of position for object manipulation is typically higher than the threshold used for tracking a path of an object, e.g. during other types of interactions with the digitizer such as writing or drawing.

According to some embodiments of the present invention, in response to a change in position of the user interaction, the transformation between the global and local coordinate system is updated so that the new positions of the user interactions in the global coordinate system will correspond to the same local coordinates previously and/or initially determined (block 570). In some exemplary embodiments, graphical object manipulation is required, e.g. translation and/or resizing of the image with respect to the global coordinates are required. According to some embodiments of the present invention, the resized and/or panned object is displayed based on the transformation calculated (block 580).

According to some embodiments of the present invention, updated global coordinates of the user interactions are sent to the host and based on a relationship between previous global coordinates and updated global coordinates, the transformation between the global and local coordinates are updated such that the position and size of the object provides for the user interactions to maintain their previous position with respect to the local coordinate system.

According to some embodiments of the present invention, displacement vectors, e.g. vector between a previous position of a user interaction and a current position of the user interaction is determined and used to manipulate the image. The displacement vectors, e.g. change in position of a user interaction, may be determined by digital unit 20 or by host 22. According to some embodiments of the present invention, as long as the user interaction is maintained within the boundaries of the object and/or at a defined area around the edges of the graphical objects, linking and/or locking of the user interaction with the image is maintained.

According to some embodiments of the present invention, manipulation of the object and linking between the user interactions and the object is terminated in response to the user interactions being lifted away from the object and/or in response to an absence of the user interactions on the object. In some exemplary embodiments, manipulation of the object is terminated only after the user interaction is absent from the boundaries of the object for a period over an absence threshold (block 585). According to some exemplary embodiments, manipulation of the object is terminated immediately in response to absence of one of the two user interactions linked to the object.

In some exemplary embodiments under specific conditions, manipulation of the object is continued when the user interaction is displaced out of a pre-defined area around the object, for example, if the user interaction moves very quickly so that a position of the user interaction off the object occurs before display of the object is updated. According to some embodiments of the present invention, in response to an absence of the user interaction, tracking the user interaction based on previous measurements is performed to determine if a user interaction identified outside of the object boundaries is the same user interaction and is a continuation of previously recorded movements. In some exemplary embodiments, in such a case if positive identification is determined the link between the user interaction and the object is maintained and manipulation of the object continues. Typically, previous positions are recorded so that tracking may be performed on demand.

According to some embodiments of the present invention, translation and/or resizing do not require any determination of the path followed by the interactions or any analysis of the motion of the two interactions. All that is necessary is the determination of the locations a pair of simultaneous interactions in global space, and transformation of the image such that these points in global space are superimposed with the original points of interactions in image space.

It is noted that such a situation may be particularly relevant for multi-touch systems where a plurality of like user interactions may concurrently interact with the touch sensitive screen. Tracking the user interaction linked with the object provides for determining if the user interaction outside of the object is the same user interaction that is linked with the object. Identification of points falling outside the defined boundary is typically based on proximity between tracked points. In some exemplary embodiments, once the display is updated so that the user interactions are within the object's boundaries tracking may not be required.

Optionally, in response to resizing the graphical object, aspect ratio of the initial area of the object is maintained. In some exemplary embodiments, resizing while the aspect ratio is locked is based on displacement of the user interactions in one of either the horizontal or vertical axis of the local coordinate system of the object. In some exemplary embodiment resizing is based on the axis recording the largest displacement. It is noted that due to locking of the aspect ratio, a graphical object may extend outside of a display area of the touch sensitive screen. In some exemplary embodiments, in response to such an occurrence, at the end of the manipulation, the object is repositioned so that it is fully viewed on the touch sensitive screen.

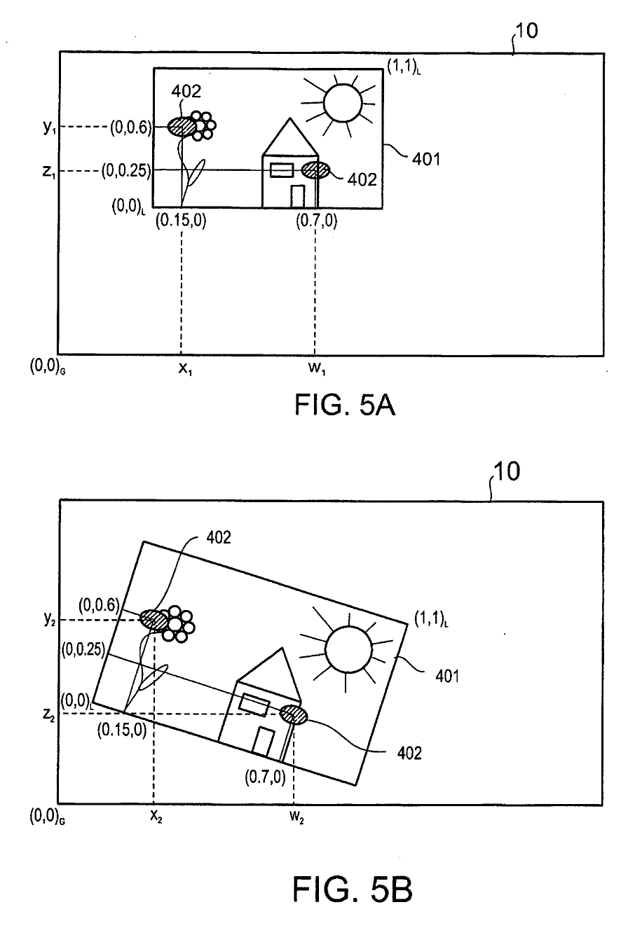

Reference is now made to FIGS. 5A and 5B showing schematic illustrations of two fingertip interactions used to displace, resize and rotate an image in accordance with some embodiments of the present invention. According to some embodiments of the present invention, a graphical object such as image 401 is displayed on a touch sensitive screen 10. According to some embodiments of the present invention, the location of each fingertip 402 is determined based on a global coordinate system of screen 10 denoted by ‘G’, e.g. (x₁,y₁)_{G} and (w₁,z₁)_{G} and based on a local coordinate system of image 401, e.g. (0.15, 0.6) and (0.7, 0.25). According to some embodiments of the present invention, the local coordinate system denoted by ‘L’ is normalized, e.g. extending between (0,0)_{L} and (1,1)_{L}.

According to some embodiments of the present invention, while the fingertips 402 move with respect to the global coordinate system from points (x₁,y₁) and (w₁,z₁) in FIG. 5A to points (x₂,y₂) and (w₂,z₂) in FIG. 5B, the positioning, orientation and size of image 401 is manipulated so that the position of fingertips 402 are substantially stationary with respect to the local coordinate system and are maintained on points (0.15, 0.8)_{L} and (0.7, 0.25)_{L}. According to some embodiments of the present invention, the local coordinate system of image 401 is reconfigured and normalized in response to each recorded displacement of fingertips 402 over a pre-defined displacement threshold.

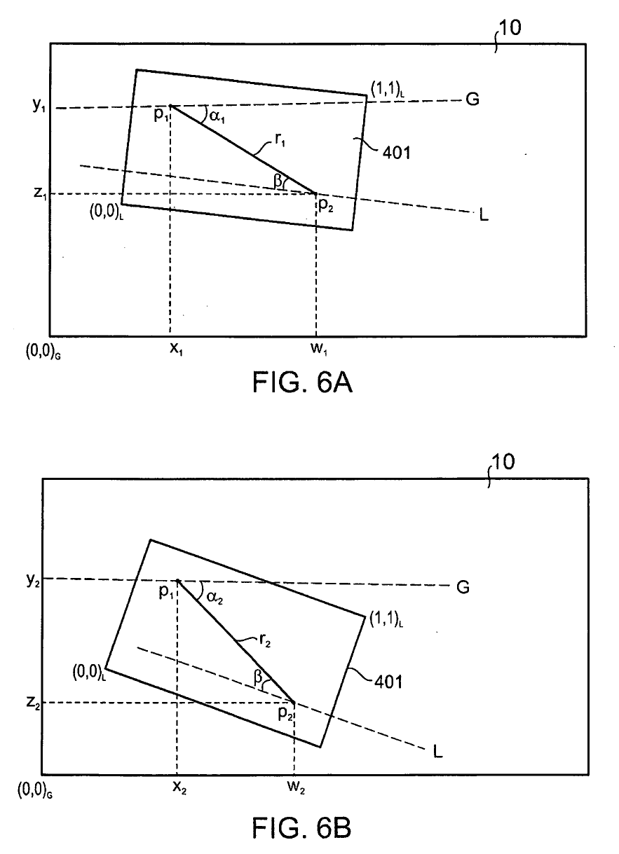

Reference is now made to FIGS. 6A and 6B schematically illustrating global manipulation of a graphical object in response to rotational movement performed with two user interactions in accordance with some embodiments of the present invention. According to some embodiments of the present invention, user interactions are positioned on points P1 and P2 with respect to object 401, such that a segment r₁ joining points P1 and P2 is at an angle α1 with respect to an axis of the global coordinate system denoted ‘G’ and an angle β with respect to an axis of the local coordinate system denoted ‘L’. According to some embodiments of the present invention points P1 and P2 are positioned on coordinates (x₁,y₁)_{G} and (w₁,z₁)_{G} respectively during capture of a first frame and on coordinates (x₂,y₂)_{G} and (w₂,z₂)_{G} respectively during capture of consecutive frame. According to some embodiments of the present invention, in response to two user interactions locked onto an object 401, the positions of the user interactions, P1 and P2, with respect to the global and local coordinate system, the length of segment r₁, as well as the angle of segment r₁ with respect to the global and local coordinate system is used to determine a geometrical transformation of object 401 on screen 10. According to some embodiments of the present invention, while connecting segment r₁ rotates with respect to an axis of global coordinate system from angle α₁ in FIG. 6A to angle α₂ in FIG. 6B, the orientation of image 401 is manipulated so that the angle β between connecting segment r₂ and the local coordinate system is maintained.

During the course of rotation, connecting segment r₁ may change its length to r₂, e.g. may be shortened or lengthened. According to some embodiments of the present invention, resizing of image 401 along the horizontal axis of the local coordinate system is based on a scale transformation factor defined by a projected length of r₂ on the horizontal axis of the local coordinate system shown in FIG. 6A divided by a projected length of r₁ on the horizontal axis of the local coordinate system shown in FIG. 6A. According to some embodiments of the present invention, resizing of image 401 along the vertical axis of the local coordinate system is likewise based on a scale transformation factor defined by a projected length of r₂ on the vertical axis of the local coordinate system shown in FIG. 6A divided by a projected length of r₁ on the vertical axis of the local coordinate system shown in FIG. 6A.

In some exemplary embodiments, aspect ratio is required to be constant by the application the scale transformation factor is simply defined by r₂/r₁. Once the orientation, e.g. angle, and the resizing is defined, translation of the image may be based on a displaced point P1 and/or updated point P2 (FIG. 6B). In some exemplary embodiments, a discrepancy may result between positioning of image 401 based on one of the two points P1 and P2. In some exemplary embodiments and in such a case, the positioning is determined by an average position based on P1 and P2 leading to typically small inaccuracies in the linking between the user interaction and the position on the screen. In some exemplary embodiments, if one of P1 and P2 remained relatively stationary as compared to the other, positioning is based on the link between the stationary user interaction and the image.

According to some embodiments of the present invention, the display is updated for each recorded change in position above a pre-defined threshold so that changes in position of each user interaction and between the user interactions are typically small enough so that discrepancies between information obtained from each of the user interactions when they occur are typically small and/or negligible. In some exemplary embodiments, links between user interactions and positions on the object are updated over the course of the manipulations.

According to some embodiments of the present invention, manipulation of the user interaction includes more than two fingers. In some exemplary embodiments, when manipulation is defined by more than two user interactions, warping of the object can be introduced. In some exemplary embodiments, warping is not desired and a third user interaction is ignored.

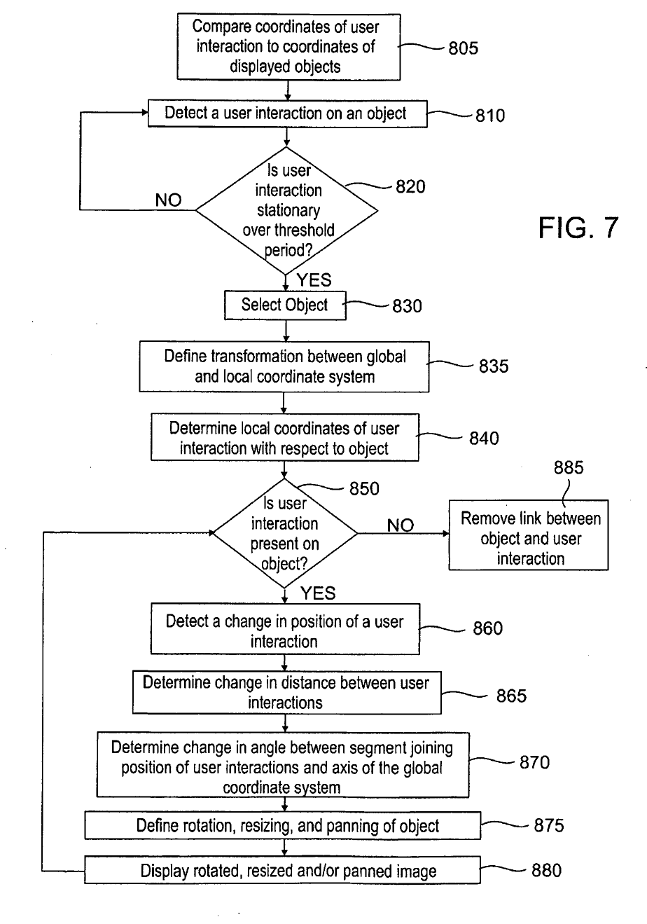

Reference is now made to FIG. 7 showing an exemplary flow chart of a method for manipulating a graphical object including translating, resizing and rotating based on displacements of user interactions on a touch sensitive screen in accordance with some embodiments of the present invention. According to some embodiments, coordinates of detected user interactions with respect to the touch sensitive screen and/or host display are transmitted to a host 22 and host 22 compares coordinates, e.g. global coordinates, of the detected user interaction to coordinates, e.g. global coordinates, of one or more currently displayed objects (block 805). In response to two or more user interactions having coordinates that are within a defined area of a currently displayed object, the user interactions are identified and determined to be on that currently displayed object (block 810). Optionally, once a presence threshold period is completed (block 820), the object(s) over which the user interactions are positioned is selected for manipulation with the identified user interactions detected on the object (block 830). According to some embodiments of the present invention, a local coordinate system for each of the objects selected is defined, e.g. a normalized coordinate system (block 835). According to some embodiments of the present invention a transformation between the global coordinate system of the display and/or touch sensitive screen and the local coordinate system is determined. According to some embodiments of the present invention, while the user interaction is still stationary, local coordinates of the position of the user interaction with respect to an object is determined (block 840). Typically, the local coordinates are determined based on the defined transformation.

According to some embodiments of the present invention, while the presence identified user interactions are maintained on the object (block 850) changes in the position of the user interactions are detected (block 860).

According to some embodiments of the present invention, in response to a change in position of the user interaction(s), a change in the distance between the user interactions is determined (block 865) and a change in an angle defined by a segment joining the two user interactions and an axis of the global coordinate system is determined (block 870). According to some embodiments of the present invention resizing of the object is based on the scale transformation factor. According to some embodiments of the present invention, rotation of the object is based on the change in angle determined. According to some embodiments of the present invention, manipulation of the object is based on a change in position of at least one of the user interactions (block 875). According to some embodiments of the present invention, once rotation, resizing and translation are determined, the manipulated object is displayed (block 880).

According to some embodiments of the present invention, updated global coordinates of the user interactions are sent to the host and based on a relationship between previous global coordinates and updated global coordinates, the transformation between the global and local coordinates are updated such that the position and size of the object provides for the user interactions to maintain their previous position with respect to the local coordinate system.

Optionally, manipulation of the object is terminated and/or the link between the object and the user interaction is terminated only after the user interaction is absent from the boundaries of the object for a period over an absence threshold (block 885).

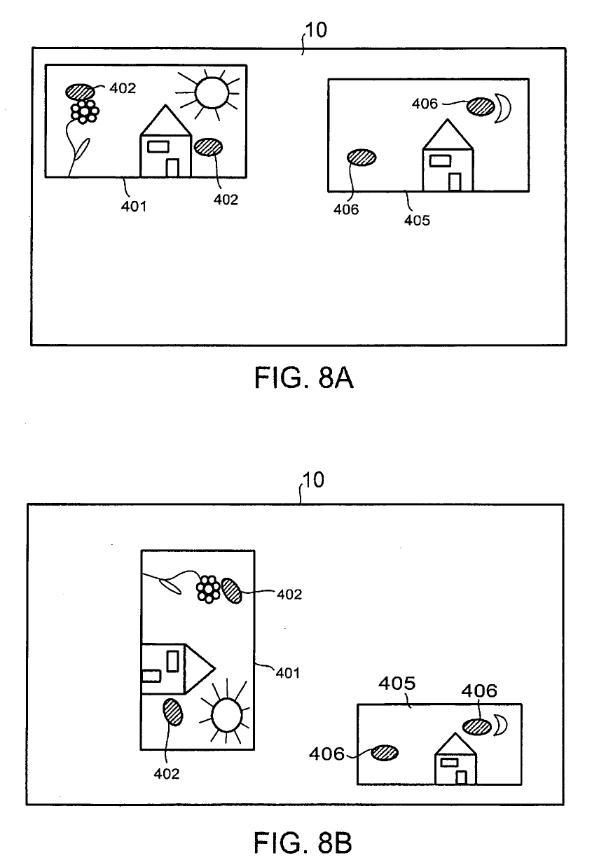

Reference is now made FIGS. 8A and 8B schematically showing fingertip interactions used to simultaneously and independently manipulate two different objects in accordance with some embodiments of the present invention. According to some embodiments of the present invention, more than one object, e.g. image 401 and image 405, displayed on touch sensitive screen 10 can be manipulated simultaneously. In some exemplary embodiments, a set of user interactions 402 may be locked onto image 401 and a different set of user interactions 406 may be locked onto image 405. In some exemplary embodiments, user interactions 402 and user interactions 406 may move simultaneously to manipulate image 401 and 405 respectively. According to some exemplary embodiments, as long as the user interactions are maintained within the boundaries of their linked object, each of the images can be manipulated independently from each other based on movement of their linked user interactions. In some exemplary embodiments, the boundary of the object includes a frame and/or a defined area around the object. For example, in FIG. 8A image 401 is positioned on the upper right hand corner of screen 10 while image 405 is positioned on the upper left hand corner of screen 10. Based on movements of user interactions 402, image 401 is rotated by 90 degrees as shown in FIG. 8B. Based on movements of user interactions 406, that may occur substantially simultaneously with movements of user interactions 402, image 405 is panned down and resized to a smaller size as shown in FIG. 8B.

According to some embodiments of the present invention, object manipulations as described herein is provided in a dedicated software application where a presence of two or more user interactions on a displayed object is indicative of selection of that object for manipulation. According to other embodiments of the present invention, object manipulation is provided as a feature of other applications and an indication and/or user input is required to switch between object manipulation mode and other modes. In some exemplary embodiments, positioning of three user interactions, e.g. three fingers, on an object serves to both switch into a mode of object manipulation and select an object to be manipulated. In response to the mode switch and the selection, either the third finger is removed or manipulation is provided by three fingers where the input from one finger may be ignored. In some exemplary embodiments, in response to an absence on the object, selection of the object is removed and object manipulation mode is terminated.

It is noted that although embodiments of the present invention may be described mostly in reference to multi-touch systems capable of differentiating between like user interactions, methods described herein may also be applied to single-touch systems capable of differentiating between different types of user interactions applied simultaneously, e.g. differentiating between a fingertip interaction and a stylus interaction.

It is further noted that although embodiments of the present invention may be described in reference to two fingertips for manipulating a graphical object, methods described herein may also be applied to different user interactions for manipulating a graphical object, e.g. two styluses, two tokens, a stylus and a token, a stylus and a finger, a finger and a token.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

What is claimed is:

1. A method for graphical object manipulation using a touch sensitive screen, the method comprising:
detecting a presence of two user interactions within a defined boundary of a graphical object displayed on the touch sensitive screen;
determining position of each of the two user interactions with respect to the graphical object;
detecting displacement of at least one of the two user interactions; and
manipulating the graphical object based on the displacement to maintain the same position of each of the two user interactions with respect to the graphical object.

2. The method according claim 1, wherein the manipulating of the graphical object provides for maintaining an angle between a line segment connecting the position of two user interactions on the graphical object and an axis of the graphical object in response to the displacement.

3. The method according to claim 1, wherein the manipulating includes resizing of the graphical object along one axis of the graphical object, and wherein the resizing is determined by a ratio of a distance between the positions of the two user interactions along the axis of the graphical object after the displacement and a distance between the positions of the two user interactions along the axis of the graphical object before the displacement.

4. The method according to claim 1, wherein the manipulating includes resizing of the graphical object, and wherein the resizing is determined by a ratio of a distance between the two user interactions after the displacement and a distance between the user interactions before the displacement.

5. The method according to claim 1, wherein the manipulating is performed as long as the at least two user interactions maintain their presence on the graphical object.

6. The method according to claim 1, wherein the defined boundary encompasses the graphical object as well as a frame around the graphical object.

7. The method according to claim 1, wherein the presence of the at least two user interactions is detected in response to stationary positioning of the two user interactions within the defined boundary of the graphical object for a pre-defined time period.

8. The method according to claim 1 wherein the touch sensitive screen includes at least two graphical objects and wherein a first set of user interactions is operative to manipulate a first graphical object and a second set of user interactions is operative to manipulate a second graphical object.

9. The method according to claim 8, wherein the first and second objects are manipulated simultaneously and independently.

10. The method according to claim 1, wherein the graphical object is an image.

11. The method according to claim 1, wherein aspect ratio of the graphical object is held constant during the manipulation.

12. The method according to claim 1, wherein the presence of one of the two user interactions is provided by hovering over the touch sensitive screen.

13. The method according to claim 1, wherein the presence of one of the two user interaction is provided by touching the touch sensitive screen.

14. The method according to claim 1, wherein the two user interactions are selected from a group including: fingertip, stylus, and conductive object or combinations thereof.

15. The method according to claim 1, wherein the manipulation does not require determination of a trajectory of the two user interactions.

16. The method according to claim 15 wherein the manipulation does not require analysis of the trajectory.

17. The method according to claim 1, wherein the touch sensitive screen is a multi-touch screen.

18. The method according to claim 1, wherein the touch sensitive screen comprises a sensor including two orthogonal sets of parallel conductive lines forming a grid.

19. The method according to claim 18, wherein the sensor is transparent.

20. A method for graphical object manipulation using a touch sensitive screen, the method comprising:
determining global coordinates of a plurality of user interactions on a touch sensitive screen, wherein the global coordinates are coordinates with respect to a global coordinate system locked on the touch sensitive screen;
detecting a presence of two user interactions within a defined boundary of a graphical object displayed on the touch sensitive screen, wherein the presence is determined from the global coordinates of the two user interactions and the global coordinates of the defined boundary of the graphical object;
defining a local coordinate system for the at least one graphical object, wherein the local coordinate system is locked on the at least one graphical object;
determining coordinates of each of the two user interactions in the local coordinate system;
detecting displacement of a position of at least one of the two user interactions; and
manipulating the at least one graphical object in response to the displacement to maintain the same coordinates of the two user interactions determined in the local coordinate system.

21. The method according to claim 20, wherein the manipulating includes one or more of resizing, translating and rotating the graphical object.

22. The method according to claim 20 comprising updating the local coordinate system of the graphical object in response to the displacement.

23. The method according to claim 20 comprising determining a transformation between the global and the local coordinate system and updating the transformation in response to the displacement.

24. The method according to claim 23 wherein the transformation is defined based on a requirement that the coordinates of the two user interactions in the local coordinate system determined prior to the displacement is the same as the coordinates of the two user interactions in the updated local coordinate system.

25. The method according to claim 20, wherein the manipulating of the graphical object provides for maintaining an angle between a line segment connecting the coordinates of two user interactions on the graphical object and an axis of the local coordinate system of the graphical object in response to the displacement and manipulating.

26. The method according to claim 20, wherein the manipulating includes resizing of the graphical object along one axis of the local coordinate system, and wherein the resizing is determined by a ratio of a distance between the two user interactions along the axis of the local coordinate system after the displacement and a distance between the two user interactions along the axis of the local coordinate system before the displacement.

27. The method according to claim 20, wherein the manipulating includes resizing of the graphical object, and wherein the resizing is determined by a ratio of a distance between the two user interactions after the displacement and a distance between the user interactions before the displacement.

28. The method according to claim 20, wherein the manipulating is performed as long as the at least two user interactions maintain their presence on the graphical object.

29. The method according to claim 20, wherein the defined boundary encompasses the graphical object as well as a frame around the graphical object.

30. The method according to claim 20, wherein the presence of the at least two user interactions is detected in response to stationary positioning of the two user interactions within the defined boundary of the graphical object for a pre-defined time period.

31. The method according to claim 20, wherein the touch sensitive screen includes at least two graphical objects and wherein a first set of user interactions is operative to manipulate a first graphical object and a second set of user interactions is operative to manipulate a second graphical object.

32. The method according to claim 31, wherein the first and second objects are manipulated simultaneously and independently.

33. The method according to claim 20, wherein the graphical object is an image.

34. The method according to claim 20, wherein aspect ratio of the graphical object is held constant during the manipulation.

35. The method according to claim 20, wherein the presence of one of the two user interactions is provided by hovering over the touch sensitive screen.

36. The method according to claim 20, wherein the presence of one of the two user interaction is provided by touching the touch sensitive screen.

37. The method according to claim 20, wherein the two user interactions are selected from a group including: fingertip, stylus, and conductive object or combinations thereof.

38. The method according to claim 20, wherein the manipulation does not require determination of a trajectory of the two user interactions.
